(19) United States
(12) Patent Application Publication
(10) Pub. No.: US 2007/0143822 A1
(43) Pub. Date: Jun. 21, 2007

(54) Receiver and tuner

(76) Inventors: Isao Hoda, Fujisawa (JP); Hitoshi Akiyama, Yokohama (JP); Takatoshi Shirosugi, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/483,776

(22) Filed: Jul. 11, 2006

(30) Foreign Application Priority Data
Dec. 20, 2005 (JP) 2005-365690

(51) Int. Cl. H04N 7/16

(52) U.S. Cl. 725/151

(57) ABSTRACT

There is provided a single receiver that can receive both of a terrestrial broadcast and a CATV broadcast, and output uplink data to the CATV broadcast. For example, the receiver includes a selector that selects one of the terrestrial broadcast signal input and the CATV signal. The receiver further includes a controller that branches or splits a CATV signal input from a CATV network through a CATV I/O terminal, or outputs the signal to the CATV network through the CATV I/O terminal, regardless of the signal selected by the selector.

### CLAIM OF PRIORITY

The present application claims priority from Japanese application serial no. JP 2005-365690, filed on Dec. 20, 2005, the content of which is hereby incorporated by reference into this application.

### BACKGROUND OF THE INVENTION

The present invention relates to a receiver and a tuner that receive terrestrial broadcast or cable television (hereinafter referred to as CATV) broadcast and that output a video and audio signals.

For digital terrestrial broadcast in the U.S., a video signal, an audio signal and a data signal are encoded and multiplexed in an MPEG2 (Moving Picture Experts Group Phase 2) format, thereby generating a TS (Transport Stream). This TS is modulated in accordance with 8VSB (Vestigial Side Band), and transmitted in a transmission band of between 54 MHz and 806 MHz.

For digital CATV broadcast in the U.S., a video signal, an audio signal and a data signal are encoded and multiplexed in an MPEG2 format, thereby generating a TS. This TS is modulated in accordance with 64QAM or 256QAM (Quadrature Amplitude Modulation), and transmitted in a transmission band of between 54 MHz and 864 MHz. Further, in the CATV broadcast, a receiver and a CATV station can transmit and receive data each other through an uplink or downlink data channel, through the use of viewer management, a viewing restriction, Video on Demand, etc.

JP-A No. 355681/1999 discloses a television broadcast receiver which can receive both the terrestrial broadcast and the CATV broadcast. This receiver includes a switch circuit which includes a high frequency relay and a switch circuit. This switch circuit selectively switches between a high frequency signal received from an external antenna connected to an antenna input terminal and a high frequency signal input from a CATV cable connected to a CATV input terminal, and performs switching of the inputs. In addition, this switch circuit having the high frequency relay performs the switching between demodulation circuits. As a result, one single receiver can correspond to all broadcast systems of the terrestrial broadcast and the CATV broadcast.

### SUMMARY OF THE INVENTION

However, the television broadcast receiver of the above patent document never mentions a technique for receiving downlink data channel from a CATV network, while receiving the terrestrial broadcast or CATV broadcast.

Further, the conventional technique has a problem wherein an input impedance of the receiver varies upon the switching operation of the switch circuit, thus causing an effect onto the CATV network.

Conventional techniques do not provide notice of a system for processing a signal (an uplink data signal) to be sent to the CATV network, in a receiver capable of receiving both the terrestrial broadcast and the CATV broadcast.

The present invention has been made in consideration of the above problem. It is accordingly an object of the present invention to provide a receiver capable of sending and receiving terrestrial broadcast and CATV broadcast.

To accomplish the above object, according to a first aspect of the present invention, there is provided a receiver including: a terrestrial input terminal that inputs a terrestrial broadcast signal; a CATV input and output (I/O) terminal that inputs a CATV signal from a CATV network, or outputs a signal to the CATV network; a branch circuit that branches or splits the CATV signal input from the CATV network through the CATV I/O terminal; a selector that selects one of the terrestrial broadcast signal input by the terrestrial input terminal and the CATV signal branched or split by the branch circuit; a main tuner that tunes to a predetermined channel from the signal selected by the selector; and a controller that controls the selector and the main tuner, wherein the controller branches or splits the CATV signal input from the CATV network through the CATV I/O terminal, or outputs the signal to the CATV network through the CATV I/O terminal, regardless of the signal selected by the selector.

According to the present invention, there can be provided a receiver capable of switching between the terrestrial broadcast and the CATV broadcast without requiring a viewer for a troublesome operation.

### BRIEF DESCRIPTION OF THE DRAWINGS

FIG. 1 is a block diagram exemplarily showing a configuration of a receiver according to a first embodiment of the present invention;

FIG. 2 is a block diagram for specifically explaining the processing carried out by two input selectors included in the receiver according to the first embodiment of the present invention;

FIG. 3 is a block diagram for specifically explaining the processing carried out by a TS switch included in the receiver according to the first embodiment of the present invention;

FIG. 4 is a block diagram exemplarily showing a configuration of a receiver according to a second embodiment of the present invention;

FIG. 5 is a block diagram for specifically explaining the processing carried out by two input selectors included in the receiver according to the second embodiment of the present invention;

FIG. 6 is a block diagram exemplarily showing a configuration of a receiver according to a third embodiment of the present invention; and

FIG. 7 is a block diagram for specifically explaining the processing carried out by a TS synthesizing switch included in the receiver according to the third embodiment of the present invention.

### DETAILED DESCRIPTION OF THE PREFERRED EMBODIMENTS

Preferred embodiments of the present invention will now specifically be described. In the preferred embodiments, the same structural components are identified with the same symbols.

### First Embodiment

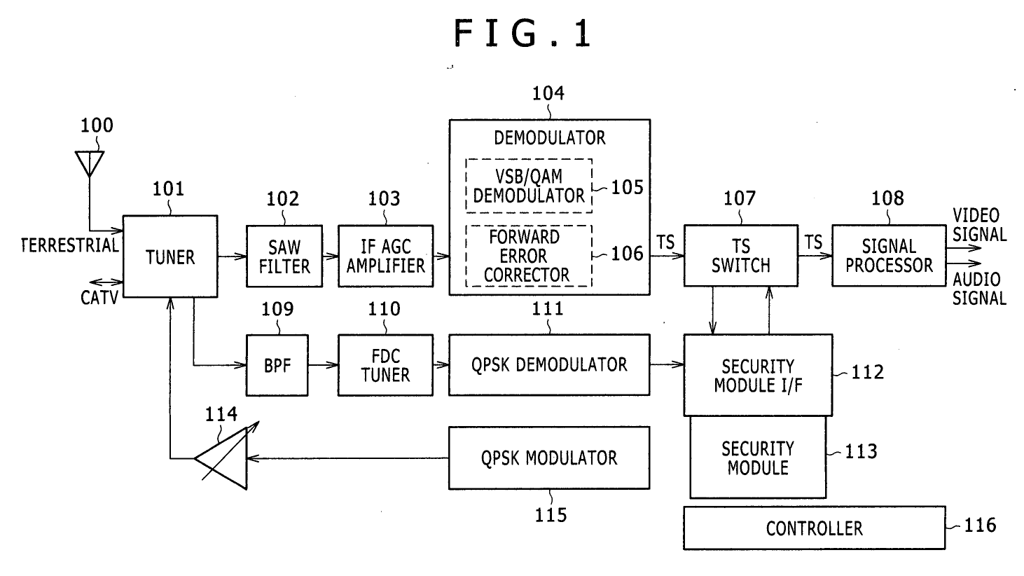

A first embodiment of the present invention will now be explained. FIG. 1 is a block diagram exemplarily showing the configuration of the receiver according to the first embodiment of the present invention.

In FIG. 1, a receiving antenna 100 receives a broadcast wave in the terrestrial broadcast, and supplies the received signal to a tuner 101. The tuner 101 has a terminal for inputting a broadcast signal transmitted through a CATV network, and receives a CATV broadcast signal supplied thereto.

The tuner 101 branches a signal for tuning a CATV downlink data channel (Out-Of-Band Forward Data Channel, hereinafter referred to as an FDC) from the supplied CATV broadcast signal. Note that this signal for tuning is transmitted in a transmission band of between 70 MHz and 130 MHz. The tuner 101 supplies the obtained signal to a band path filter 109. On the FDC, a signal that has been modulated in accordance with a QPSK (Quadrature Phase Shift Keying) technique is transmitted. The band path filter 109 has a pass band of between 70 MHz and 130 MHz, restricts the band of the supplied FDC signal, and then supplies the signal to an FDC tuner 110.

The FDC tuner 110 converts the frequency of the supplied FDC signal into a predetermined IF band of, for example, 44 MHz, adjusts the signal level, and supplies the signal to a QPSK demodulator 111. The QPSK demodulator 111 demodulates the supplied FDC signal. The demodulated data demodulated by the QPSK demodulator is supplied to a security module 113 through a security module interface 112. The QPSK demodulator 111 controls the signal level of the FDC tuner 110.

The tuner 101 has an input terminal for a CATV uplink data channel (Out-Of-Band Reversed Data Channel, hereinafter referred to as “RDC”) for a signal sent from a receiver in a transmission band of between 5 MHz and 42 MHz. An RDC signal is obtained by a QPSK modulator 115, i.e. by QPSK modulating data supplied from a controller 116. The level of the obtained RDC signal is adjusted to a predetermined level corresponding to a CATV network, and sent to the CATV network through the tuner 101.

Further, the tuner 101 tunes to a desired channel from the supplied terrestrial broadcast signal or the CATV broadcast signal. In the U.S., the terrestrial broadcast signal is modulated in accordance with an 8VSB technique, and transmitted in a transmission band of between 54 MHz and 806 MHz. On the contrary, in the U.S., the CATV broadcast signal is modulated using a 64AQM or 256QAM technique, and transmitted in a transmission band of between 54 MHz and 864 MHz. Particularly, the transmission band for transmitting the CATV broadcast signal is called “In-Band”. In the “In-Band”, a video signal, an audio signal and a data signal that are encoded in an MPEG2 format are transmitted. The channel included in the In-Band is called an “FAT channel” (Forward Application Transport Channel), as opposed to the FDC and RDC.

The broadcast signal tuned by the tuner 101 is supplied to a SAW filter 102. The SAW filter 102 is a 6 MHz band filter, restricts the band of the supplied broadcast signal, and supplies the signal to an IF AGC amplifier 103. The IF AGC amplifier 103 adjusts the level of the supplied broadcast signal to an optimum level for a demodulator 104, and supplies the broadcast signal thereto. The demodulator 104 includes an 8VSB/QAM demodulator 105 and a forward error corrector 106, demodulates and corrects errors of the supplied broadcast signal in accordance with a corresponding broadcast system, and supplies a TS (Transport Stream) signal to a TS switch 107. Note that the demodulator 104 controls the signal level of the IF AGC amplifier 103.

The TS switch 107 switches the path of the supplied TS signal to directly be supplied to a decoder 108 or through the security module interface 112 and the security module 113. The security module 113 cancels a viewing restriction of the supplied TS signal, and supplies the signal to the TS switch 107 through the security module interface 112. The decoder 108 executes a demultiplexing process, an encryption process for the supplied TS signal, thereby outputting a video and audio signals.

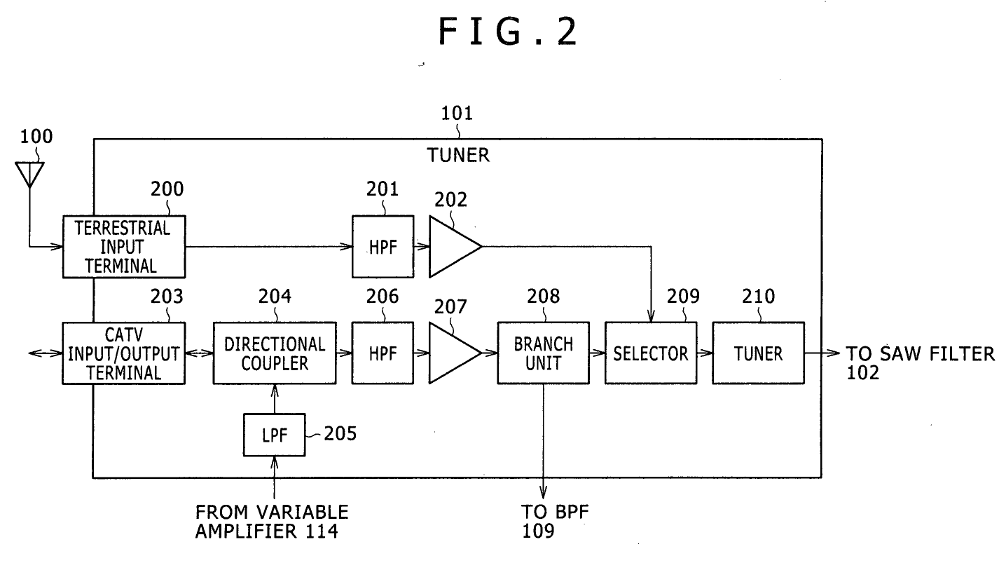

A description will now be made of a process to be executed by the tuner 101 shown in FIG. 1. FIG. 2 is a block diagram for specifically explaining the tuner 101 shown in FIG. 1. The tuner 101 has a terrestrial input terminal 200 for inputting a terrestrial broadcast signal received by the receiving antenna 100 and a CATV input/output (I/O) terminal 203 for inputting a broadcast signal transmitted through a CATV network. It is assumed that the input terminals 200 and 203 are terminals, such as F-type connectors, etc., but they are not limited to such terminals.

The terrestrial broadcast signal input to the terrestrial input terminal 200 is supplied to an amplifier 202 through a high pass filter 201, having a pass band equal to or greater than 54 MHz. The amplifier 202 amplifies the supplied terrestrial broadcast signal, and supplies the amplified signal to a selector 209.

The CATV broadcast signal supplied to the CATV I/O terminal is supplied to a high pass filter 206 through a directional coupler 204. The high pass filter 206 transmits any frequency signal equal to or greater than 54 MHz from the supplied CATV broadcast signal, and supplies the transmitted signal to an amplifier 207. The amplifier 207 amplifies the supplied CATV broadcast signal, and supplies the amplified signal to a branch unit 208.

The branch unit 208 branches the supplied CATV broadcast signal into an FAT channel signal and an FDC signal, and supplies the FAT channel signal and the FDC signal respectively to the selector 209 and the band pass filter 109 shown in FIG. 1. The selector 209 selects either the supplied terrestrial broadcast signal or the CATV broadcast signal, and supplies the selected signal to a tuner 210. The tuner 210 converts the frequency of one channel from the supplied broadcast signals into a predetermined IF band (e.g. 44 MHz), adjusts its level, and supplies the signal to the SAW filter 102.

The RDC signal supplied from a variable amplifier 114 passes through a low pass filter, having a pass band equal to or lower than 54 MHz, and is supplied to the directional coupler 204. The directional coupler 204 outputs the RDC signal to the CATV I/O terminal 203 to send the signal onto a CATV network, but intercepts the signal on the side of the high pass filter 206.

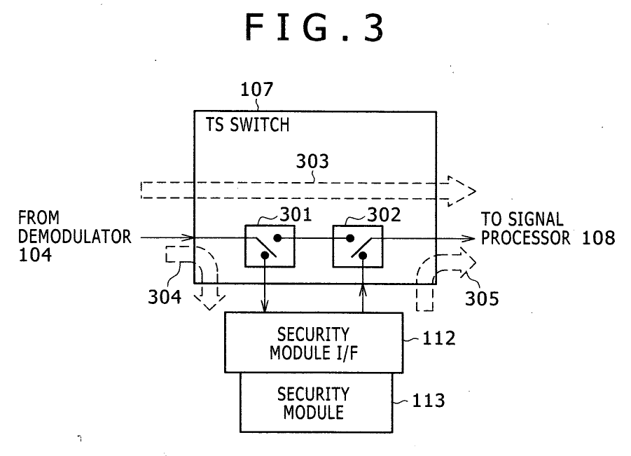

A description will now be made of a process to be executed by the TS switch 107 shown in FIG. 1. FIG. 3 is a block diagram for specifically explaining the TS switch 107 shown in FIG. 1. In FIG. 3, reference numerals 301 and 302 refer to switches which can select the path of each TS, and reference numerals 303 and 304 refer to the path of each TS.

The TS signal input to the TS switch 107 includes a data signal, a clock signal, a synchronizing signal, an enable signal and an error signal. The switches 301 and 302 perform the switching under the control of the controller 116, and can switch between the TS paths, passing through or not through the security module 113.

Though not illustrated in FIGS. 1 to 3, the controller 116 totally controls the processing carried out by the tuner 101, the demodulator 104, the TS switch 107, the decoder 108, the QPSK demodulator 111 and the QPSK modulator 115.

A description will now be made of a process for tuning with the use of the receiver according to this embodiment.

The terrestrial broadcast is tuned, in response to a tuning operation based on a user operation or reservation for viewing or recording. In this case, the controller 116 controls the selector 209 to supply a terrestrial broadcast signal to the tuner 210, and controls also the demodulator 104 to demodulate and correct errors of the signal in accordance with the terrestrial broadcast system. At the same time, the controller 116 controls the switches 301 and 302 to select (switch) the path (TS path 303) not passing through the security module 113 in TS switch 107.

The CATV broadcast is tuned, in response to a tuning operation based on a user operation or reservation for viewing or recording. The controller 116 controls the selector 209 to supply a CATV broadcast signal to the tuner 210, and controls also the demodulator 104 to demodulate and correct errors of the signal in accordance with the CATV broadcast system. Further, if the security module 113 is inserted into the security module interface 112, to execute a descrambling process, the controller 116 controls the switches 301 and 302 to switch to the path (from TS path 304 to TS path 305) passing through the security module 113, in the TS switch 107. On the other hand, if the security module 113 is not inserted into the security module interface 112, the controller 116 controls the switches 301 and 302 to switch to the path (TS path 303) not passing through the security module 113, in the TS switch 107.

The tuning/demodulation process for the FDC and the modulation process for the RDC can be executed, while the security module 113 is inserted into the security module interface 112. Because the CATV signal is input to the FDC tuner 110 regardless of whether the selected signal is a terrestrial broadcast signal or a CATV broadcast signal, the FDC data is always supplied to the security module 113. The RDC signal can always be sent to a CATV network while the security module 113 is inserted into the security module interface 112. The input impedance of the CATV I/O terminal 203 is constant regardless of the path selected by the selector 209, and thus reducing an effect, such as signal reflection, etc. to the CATV network.

According to the above operations, one single receiver can receive both of the terrestrial broadcast and the CATV broadcast (capable of bidirectional communication services), thus providing a receiver that does not require a viewer for any troublesome operation for tuning the terrestrial or CATV broadcast. Further, the amplifiers are provided for the respective terrestrial broadcast signal and the CATV broadcast signal. According to this configuration, there can be provided a receiver having an input impedance that does not vary upon the switching operation between the terrestrial broadcast and the CATV broadcast.

Further, a branch unit for the FDC signal is provided in the preceding stage of the selector for selecting the terrestrial broadcast or the CATV broadcast. In this configuration, the reception sensitivity for the terrestrial broadcast can be secured without deteriorating the NF (Noise Figure), when receiving the terrestrial broadcast signal.

If the tuner 101 of FIG. 2 is enclosed in a metal case, the noise tolerance from external noise can be improved. Even if any of the components elements shown in FIGS. 1 and 2 is enclosed in a case, the effect of the present invention can still be maintained.

If one of the component elements shown in FIG. 2 is sold as a product, its versatility can be expected for those skilled in the art when designing the receiver, thereby lowering the cost for the system configuration and enhancing- the degree of designing freedom.

### Second Embodiment

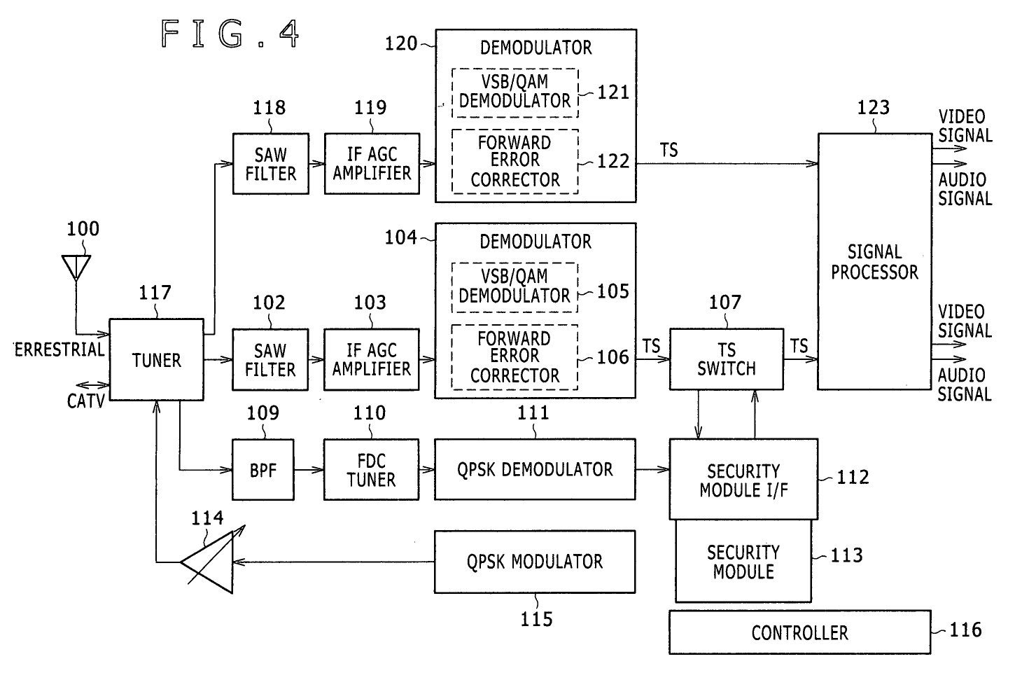

A second embodiment of the present invention will now be explained. FIG. 4 is a block diagram exemplarily showing a configuration of a receiver according to this embodiment.

In addition to the configuration of the receiver according to the first embodiment, the receiver of this embodiment includes one receiver unit that tunes and demodulates a terrestrial broadcast signal and a CATV broadcast signal (FAT channel). In FIG. 4, a tuner 117 tunes to a predetermined channel from an input terrestrial broadcast signal and a CATV broadcast signal, and supplies the signal to the SAW filter 102. In addition, the tuner 117 tunes to a predetermined channel from an input terrestrial broadcast signal and a CATV broadcast signal, and supplies the signal to a SAW filter 118. Either the terrestrial broadcast signal or the CATV broadcast signal can arbitrarily be supplied to the SAW filter 102 and the SAW filter 118 without any restriction of the tuned channel.

The broadcast signal supplied to the SAW filter 102 is processed by the IF AGC amplifier 103 and the demodulator 104 in the same manner as described in the first embodiment, and a resultant TS signal is supplied to the TS switch 107. The broadcast signal supplied to the SAW filter 118 is processed by an IF AGC amplifier 119 and a demodulator 120 in the same manner as described in the first embodiment, and then a resultant TS signal is supplied to a decoder 123.

The TS switch 107 can switch (select) whether the supplied TS signal is supplied to the decoder 108 directly or through the security module interface 112 and the security module 113, and performs the same processing described in the first embodiment. The decoder 123 executes a demultiplexing process and a decoding process for two series of the supplied TS signal, thereby outputting video and audio signals. Such video and audio signals to be output may be data for displaying a video image obtained from the two series of the TS on one display screen.

Further, the tuner 117 has an output terminal for the FDC signal and an input terminal for the RDC signal, like the tuner 101 shown in FIG. 1, and executes the processing with respect to the band pass filter 109, the FDC tuner 110, the QPSK demodulator 111, the variable amplifier 114 and the QPSK modulator 115 in the same manner as described in the first embodiment.

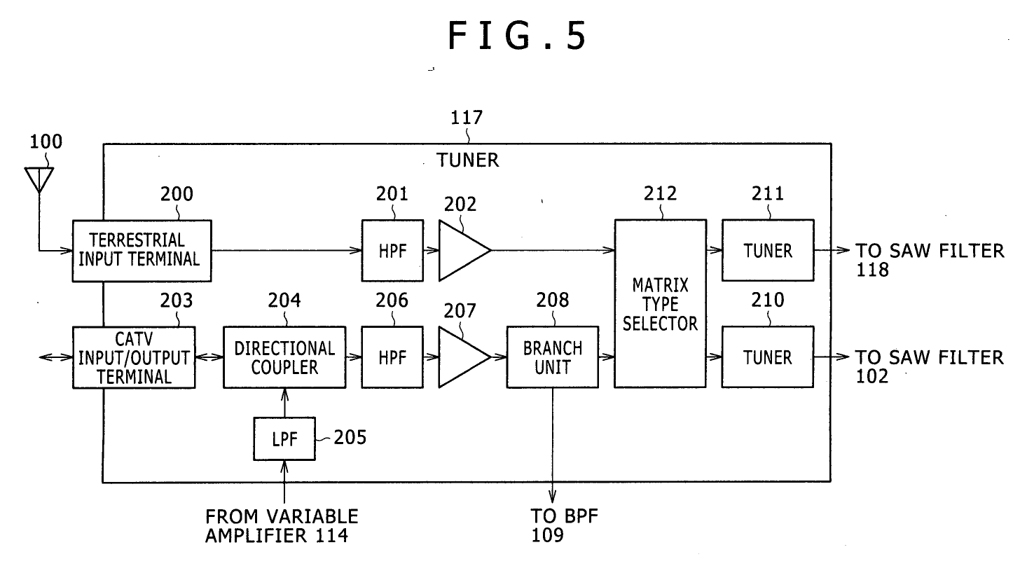

A description will now specifically be made of a process to be executed by the tuner 117 show in FIG. F4. FIG. 5 is a block diagram for specifically explaining the tuner 117 shown in FIG. 4. In this embodiment, the tuner 117 has a matrix type selector 212 that can select an output destination of target data, in place of the selector 209 of the tuner 101 included in the receiver according to the first embodiment. Further, the-tuner 117 includes a tuner 211 that supplies a broadcast signal to the SAW filter 118 added in FIG. 4.

The matrix type selector 212 selects one of the supplied terrestrial broadcast signal and the CATV broadcast signal, and supplies the selected signal to the tuner 210. The matrix type selector 212 selects the other one of the supplied terrestrial broadcast signal and the CATV broadcast signal, and supplies the selected signal to the tuner 211. Either the terrestrial broadcast signal or the CATV broadcast signal can arbitrarily be selected and supplied to the tuner 210 and the tuner 211. Each of the tuners 210 and 211 converts the frequency of the supplied signal corresponding to a channel, into a predetermined IF band (e.g. 44 MHz), adjusts its signal level, and supplies the signal to the SAW filter 102 or SAW filter 118 shown in FIG. 4.

Though not illustrated in FIGS. 4 and 5, the controller 116 controls the processing carried out by the demodulators 104 and 120, the TS switch 107, the decoder 123, the QPSK demodulator 111, the QPSK modulator 115 and the tuner 117.

A description will now be made of a tuning process executed by the receiver of this embodiment.

The tuners 210 and 211 both tune to the terrestrial broadcast, in response to a tuning operation based on a user operation or a reservation for viewing or recording. In this case, the controller 116 controls the matrix type selector 212 to supply the terrestrial broadcast signal to the tuners 210 and 211, and controls also the demodulators 104 and 120 to demodulate and correct errors of the signal in accordance with the terrestrial broadcast system. At the same time, the controller 116 controls the switches 301 and 302 to switch to the path (TS path 303) not passing through the security module 113, in the TS switch 107.

The tuners 210 and 211 both tune to the CATV broadcast, in response to a tuning operation based on a user operation or a reservation for viewing or recording. In this case, the controller 116 controls the matrix type selector 212 to supply the CATV broadcast signal to the tuners 210 and 211, and controls also the demodulators 104 and 120 to demodulate and correct errors of the signal in accordance with the CATV broadcast system. Further, if the security module 113 is inserted into the security module interface 112, the controller 116 controls the switches 301 and 302 to switch to the path (from TS path 304 to TS path 305) that passes through the security module 113, in the TS switch 107, to execute a descrambling process. On the contrary, if the security module 113 is not inserted into the security module interface 112, the controller 116 controls the switches 301 and 302 to switch to the path (TS path 303) that does not pass through the security module 113, in the TS switch 107.

The tuners tune respectively to the terrestrial broadcast and the CATV broadcast, in response to a tuning operation based on a user operation or a reservation for viewing or recording. In this case, the controller 116 controls the matrix type selector 212 to supply the CATV broadcast signal to the tuner 210 and the terrestrial broadcast signal to the tuner 211. In addition, the controller 116 controls the demodulator 104 to demodulate and correct errors of the signal in accordance with the CATV broadcast system, and controls the demodulator 120 to demodulate and correct errors of the signal in accordance with the terrestrial broadcast system.

To execute a descrambling process, the controller 116 controls the switches 301 and 302 to switch to the path (from TS path 304 to TS path 305) that passes through the security module 113, in the TS switch 107, if the security module 113 is inserted into the security module interface 112. On the contrary, if the security module 113 is not inserted into the security module interface 112, the controller 116 controls the switches 301 and 302 to switch to the path (TS path 303) that does not pass through the security module 113, in the TS switch 107.

The tuning/demodulation process for the FDC and the modulation process for the RDC can be executed, while the security module 113 is inserted into the security module interface 112. Because the CATV signal is supplied to the FDC tuner 110 regardless of whether the selected signal is a terrestrial broadcast signal or a CATV broadcast signal, the FDC data is always supplied to the security module 113.

The RDC signal can always be sent to the CATV network, while the security module 113 is inserted into the security module interface 112. The input impedance of the CATV I/O terminal 203 is constant regardless of the path selected by the selector 209, thus reducing an effect, such as data reflection, etc. to the CATV network.

According to the above operations, one single receiver can receive both of the terrestrial broadcast and the CATV broadcast (capable of bidirectional communication services), thus providing a receiver that does not require a viewer for any troublesome operation for switching between the terrestrial or CATV broadcast. When displaying any combination of the terrestrial broadcast and the CATV broadcast, the receiver of this embodiment can output video/audio data for displaying such broadcast in the form of two-display screens or representing a program of a different channel.

If the CATV broadcast signal (restricted for viewing) is received by the SAW filter 118, the IF AGC amplifier 119 and the demodulator 120 shown in FIG. 4, the descrambling process cannot be executed by the security module 113. Hence, this receiver unit can be set only for the terrestrial broadcast.

Further, the amplifiers are provided for the respective terrestrial broadcast signal and the CATV broadcast signal. According to this configuration, there can be provided a receiver having an input impedance that does not vary upon the switching operation between the terrestrial broadcast and the CATV broadcast. Further, a branch unit for the FDC signal is provided in the preceding stage of the switch for switching between the terrestrial broadcast and the CATV broadcast. In this configuration, the reception sensitivity for the terrestrial broadcast can be secured without deteriorating the NF (Noise Figure), when receiving the terrestrial broadcast signal.

If the tuner 101 of FIG. 5 is enclosed in a metal case, the noise tolerance from external noise can be improved. Even if any of the component elements shown in FIGS. 1 and 2 is enclosed in a case, the effect of the present invention can still be maintained.

In this embodiment, the description has been made to the operation of the receiver having two demodulators. Needless to say, however, the receiver can include three or more demodulators.

### Third Embodiment

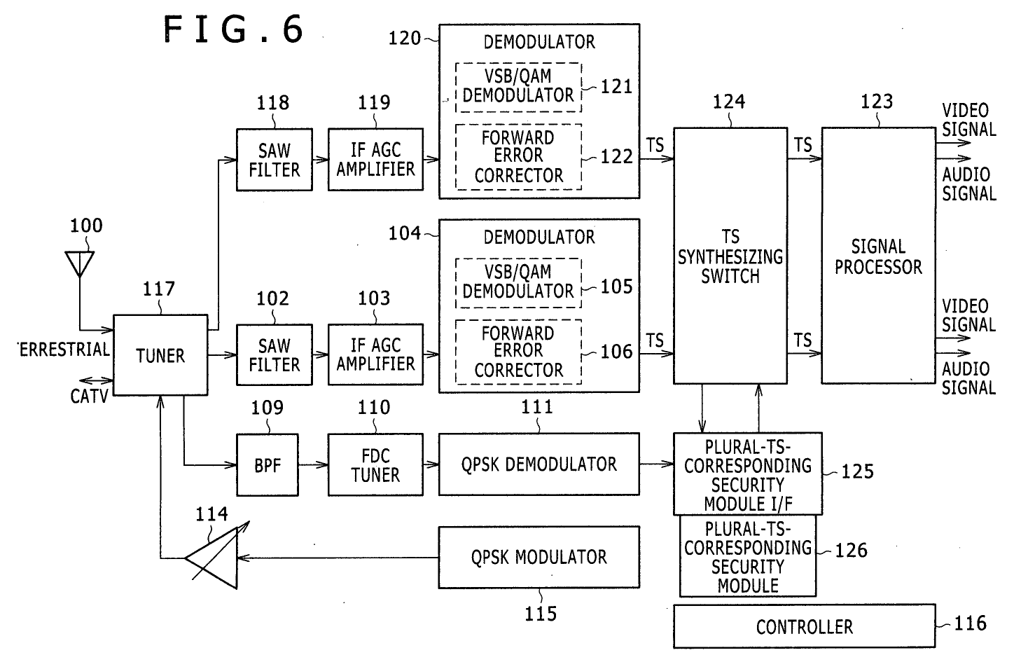

A third embodiment of the present invention will now be described. FIG. 6 is a block diagram exemplarily showing the configuration of a receiver according to this embodiment.

The receiver of this embodiment includes a TS synthesizing switch 124 in place of the TS switch 107 included in the receiver of the second embodiment. The TS signal output from the demodulator 120 is supplied to the decoder 123 through the TS synthesizing switch 124. In this embodiment, a plural-TS-corresponding security module interface 125 and a plural-TS-corresponding security module 126 are provided respectively in place of the security module interface 112 and the security module 113.

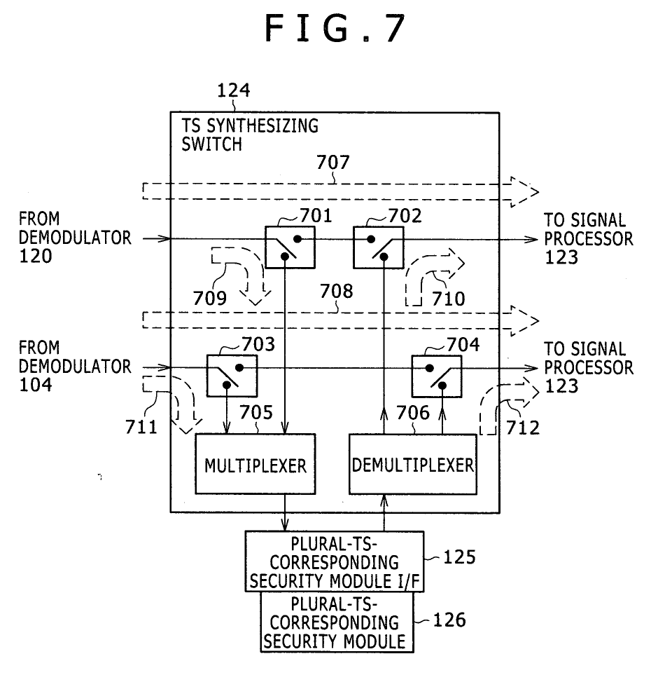

A description will now be made of a process to be executed by the TS synthesizing switch 124 shown in FIG. 6. FIG. 7 is a block diagram for specifically explaining the TS synthesizing switch 124 shown in FIG. 6. In FIG. 7, reference numerals 701, 702, 703 and 704 refer to switches each of which can select a corresponding TS path. Reference numerals 707, 708, 709, 710, 711 and 712 refer to the TS paths. The TS signal to be input to the TS synthesizing switch 124 includes a data signal, a clock signal, a synchronizing switch, an enable signal and an error signal.

The switches 701, 702, 703 and 704 perform the switching under the control of the controller 116. A multiplexer 705 multiplexes plural input TS signals in accordance with the plural-TS-corresponding security module 126, and sends the multiplexed signals to the plural-TS-corresponding security module 126 through the plural-TS-corresponding security module interface 125. The plural-TS-corresponding security module 126 executes a descrambling process for the supplied signals, and supplies the signals to a demultiplexer 706.

The demultiplexer 706 demultiplexes the supplied multiplexed TS signals into plural transport streams (TS). Of the demultiplexed transport streams, the TS signal input originally through the switch 703 is supplied to the switch 704, while the TS signal input originally through the switch 701 is supplied to the switch 702.

A description will now specifically be made of a tuning process to be executed by the receiver of this embodiment. The tuners 210 and 211 both tune to the terrestrial broadcast, in response to a tuning operation based on a user operation or a reservation for viewing or recording. In this case, the controller 116 controls the matrix type selector 212 to supply a terrestrial broadcast signal to the tuners 210 and 211, and controls the demodulators 104 and 120 to demodulate and correct errors of the signal based on a demodulation and error correction method corresponding to the terrestrial broadcast system.

At the same time, the controller 116 controls the switches 701, 702, 703 and 704 to switch to paths (TS paths 707 and 708) of the TS signal supplied from the demodulators 104 and 120 in the TS synthesizing switch 124. These paths 707 and 708 do not pass through the plural-TS-corresponding security module 126.

The tuners 210 and 211 both tune to the CATV broadcast, in response to a tuning operation based on a user operation or a reservation for viewing or recording. In this case, the controller 116 controls the matrix type selector 212 to supply a CATV broadcast signal to the tuners 210 and 211, and controls the demodulators 104 and 120 to demodulate and correct errors of the signal based on a demodulation and error correction method corresponding to the CATV broadcast system.

If the plural-TS-corresponding security module 126 is inserted into the plural-TS-corresponding security module interface 125, to execute a descrambling process, the controller 116 controls the switches 701, 702, 703 and 704 to switch to the paths (from TS path 711 to TS path 712, from TS path 709 to TS path 710) that pass through the plural-TS-corresponding security module 126 in the TS synthesizing switch 124.

On the contrary, if the plural-TS-corresponding security module 126 is not inserted into the plural-TS-corresponding security module 125, the controller 116 controls the switches 701, 702, 703 and 704 to switch to the paths (TS paths 707 and 708) of the TS signals supplied from the demodulators 104 and 120 in the TS synthesizing switch 124. These paths 707 and 708 do not pass through the plural-TS-corresponding security module 126.

The tuners tune respectively to the terrestrial broadcast and the CATV broadcast, in response to a tuning operation based on a user operation or a reservation for viewing or recording. In this case, the controller 116 controls the matrix type selector 212 to supply the CATV broadcast signal to the tuner 210 and to supply the terrestrial broadcast signal to the tuner 211. In addition, the controller 116 controls the demodulator 104 to demodulate and correct errors of the CATV signal based on a demodulation and error correction method corresponding to the CATV broadcast system, and controls the demodulator 120 to demodulate and correct errors of the terrestrial broadcast signal based on a demodulation and error correction method corresponding to the terrestrial broadcast.

Further, if the plural-TS-corresponding security module 126 is inserted into the plural-TS-corresponding security module interface 125, to execute a descrambling process, the controller 116 controls the switches 701 and 704 to switch to the path (TS path 711 to TS path 712) of the TS signal supplied from the demodulator 104 in the TS synthesizing switch 125. This path passes through the plural-TS-corresponding security module 126. In addition, the controller 116 controls the switches 702 and 703 to switch to the path (TS path 708) of the TS signal supplied from the demodulator 120, not passing through the plural-TS-corresponding security module 126.

On the contrary, if the plural-TS-corresponding module 126 is not inserted into the plural-TS-corresponding security module interface 125, the controller 116 controls the switches 701, 702, 703 and 704 to switch to the paths (TS path 707 and TS path 708) of the TS signals supplied from the demodulators 104 and 120 in the TS synthesizing switch 124. These paths do not pass through the plural-TS-corresponding security module 126.

The tuning/demodulation process for the FDC and the modulation process for the RDC can be executed, while the security module 113 is inserted into the security module interface 112. The CATV signal to be input to the FDC tuner 110 is supplied regardless of whether the selected signal is a terrestrial broadcast signal or a CATV broadcast signal. Therefore, the FDC data is always supplied to the security module 113.

The RDC signal can always be sent to the CATV network, while the security module 113 is inserted into the security module interface 112. The input impedance of the CATV I/O terminal 203 is constant regardless of the path selected by the selector 209, thus reducing an effect, such as data reflection, etc. onto the CATV network.

According to the above operations, one single receiver can receive the terrestrial broadcast and the CATV broadcast (capable of bi-direction communication services), thus providing a receiver that does not require a viewer for any troublesome operation for switching between the terrestrial or CATV broadcast. When displaying any combination of the terrestrial broadcast and the CATV broadcast, video/audio data representing such broadcast can be displayed in the form of two-display screens, or video/audio data representing a program of a different channel can be output. While the plural-TS-corresponding security module 126 is inserted, the receiver of this embodiment can output the video/audio data for displaying the broadcast or for recording a program on a different channel, even when a view restriction CATV broadcast signal is received.

The amplifiers are provided respectively for the terrestrial broadcast signal and the CATV broadcast signal. According to this configuration, there can be provided a receiver having an input impedance that does not vary upon the switching operation between the terrestrial broadcast and the CATV broadcast. Further, a branch unit for the FDC signal is provided in the preceding stage of the selector for selecting the terrestrial broadcast or the CATV broadcast. In this configuration, the reception sensitivity for the terrestrial broadcast can be secured without deteriorating the NF (Noise Figure), when receiving the terrestrial broadcast signal.

If the tuner 101 of FIG. 5 is enclosed in a metal case, the noise tolerance from external noise can be improved. Even if any of the component elements shown in FIGS. 1 and 2 is enclosed in a case, the effect of the present invention can still be maintained.

In this embodiment, the description has been made of the operation of the receiver having two demodulators. Needless to say, however, the receiver can have three or more than three demodulators.

In the above embodiments, the descriptions have been made of the operation based on the modulation method and transmission band in a manner corresponding to the terrestrial broadcast and CATV broadcast in the U.S. However, the same effect can be obtained using different modulation and transmission methods.

The present invention is not limited to the above embodiments, and various modifications can be made without departing from the broad scope of the invention. The aforementioned embodiments cover various inventions, and various inventions can be obtained in appropriate combination of the disclosed constituent features. For example, when various omissions are made from any constituent features of the above embodiments, even if at least one of the above-described objects is solved and one of the above-described effects of the invention is obtained, the present invention can be made with the configuration excluding such constituent features.

What is claimed is:

1. A receiver comprising:
a terrestrial input terminal that inputs a terrestrial broadcast signal;
a CATV input and output (I/O) terminal that inputs a CATV signal from a CATV network, or outputs a signal to the CATV network;
a branch circuit that branches or splits the CATV signal input from the CATV network through the CATV I/O terminal;
a selector that selects one of the terrestrial broadcast signal input by the terrestrial input terminal and the CATV signal branched or split by the branch circuit;
a main tuner that tunes to a predetermined channel from the signal selected by the selector; and
a controller that controls the selector and the main tuner,
wherein the controller branches or splits the CATV signal input from the CATV network through the CATV I/O terminal, or outputs the signal to the CATV network through the CATV I/O terminal, regardless of the signal selected by the selector.

2. A receiver capable of receiving both terrestrial broadcast and CATV broadcast, the receiver comprising:
a terrestrial input terminal that inputs a terrestrial broadcast signal;
a CATV input and output (I/O) terminal that inputs a CATV signal, or outputs a CATV broadcast uplink data signal to a CATV network;
a directional coupler that transmits the CATV signal, and couples the uplink data signal to the CATV network;
a branch circuit that branches or splits a downlink data signal from the CATV signal transmitted through the directional coupler;
a selector that selects one broadcast signal from the terrestrial broadcast signal input by the terrestrial input terminal and the CATV signal branched or split by the branch circuit;
a main tuner that tunes to a predetermined channel from the signal selected by the selector; and
a controller that controls the selector and the main tuner,
wherein the controller can control the selector in accordance with a predetermined broadcast signal, branch or split the downlink data signal and output the uplink data signal regardless of the broadcast signal selected by the selector.

3. The receiver according to claim 2, further comprising:
a first amplifier that amplifies the terrestrial broadcast signal input by the terrestrial input terminal; and
a second amplifier that amplifies the CATV signal input by the CATV I/O terminal.

4. The receiver according to claim 2, further comprising:
a main demodulator that executes a demodulating process for demodulating the broadcast signal tuned by the main tuner;
a module interface into which a module for canceling a viewing restriction is inserted;
a TS switch that switches a path of the signal demodulated by the main demodulator;
a decoder that executes a decoding process for decoding the signal of the path switched by the TS switch;
a sub tuner that tunes the downlink data signal branched or split by the branch circuit; and
a sub demodulator that executes a demodulating process for demodulating the signal tuned by the sub tuner,
wherein the controller controls whether the signal demodulated by the sub demodulator passes through the module interface.

5. The receiver according to claim 4,
wherein the controller controls the signal demodulated by the main demodulator not to pass through the module interface, when the broadcast signal selected by the selector is a terrestrial broadcast signal; and
the controller controls the signal demodulated by the main demodulator to pass through the module interface, when the broadcast signal selected by the selector is a CATV signal.

6. The receiver according to claim 4, further comprising:
a modulator that modulates uplink data signal, and
wherein the uplink data modulated by the modulator is supplied to the directional coupler.

7. A receiver capable of receiving both terrestrial broadcast and CATV broadcast, comprising:
a terrestrial input terminal that inputs a terrestrial broadcast signal;
a CATV input and output (I/O) terminal that inputs a CATV signal, and sends an uplink data signal for the CATV broadcast to a CATV network;
a directional coupler that transmits the CATV signal, and couples the uplink data signal to the CATV network;
a branch circuit that branches or splits a downlink data signal from the CATV signal transmitted through the directional coupler;
a selector that selects one broadcast signal in a one-to-one correspondence to a tuner from the terrestrial broadcast signal input by the terrestrial input terminal and the CATV signal branched or split by the branch circuit;
at least one main tuner that tunes to a predetermined channel from the broadcast signal selected by the selector; and
a controller that controls the selector and the at least one main tuner,
wherein the controller controls the selector in accordance with a predetermined broadcast signal to be tuned by the at least one main tuner, and
the controller can branch or split the downlink data signal and send the uplink data signal regardless of the broadcast signal selected by the selector.

8. The receiver according to claim 7, further comprising:
a first amplifier that amplifies the broadcast signal input by the terrestrial input terminal; and
a second amplifier that amplifies the broadcast signal input by the CATV I/O terminal.

9. The receiver according to claim 7, further comprising:
at least one main demodulator that demodulates the broadcast signal tuned by the at least one main tuner in accordance with a corresponding broadcast system;
a module interface into which a module for canceling a viewing restriction for a plurality of signals is inserted;
a TS switch that switches a path of the signal demodulated by the at least one main demodulator;
a multiplexer that multiplexes the signal demodulated by the at least one main demodulator;
a demultiplexer that demultiplexes a multiplexed signal whose viewing restriction is canceled by the module, into a plurality of signals;
a decoder that executes a decoding process for decoding the signal of the path switched by the TS switch;
a sub tuner that tunes the downlink data signal branched or split by the branch circuit; and
a sub demodulator that executes a demodulating process for demodulating the signal tuned by the sub tuner,
wherein the controller controls whether at least one signal demodulated by the at least one main demodulator passes through the module interface.

10. The receiver according to claim 9,
wherein the controller controls the signal demodulated by the main demodulator not to pass through the module interface, when the broadcast signal selected by the selector is a terrestrial broadcast signal; and
the controller controls the signal demodulated by the main demodulator to pass through the module interface, when the broadcast signal selected by the selector is a CATV signal.

11. The receiver according to claim 9, further comprising
a modulator that modulates the uplink data, and wherein
the uplink data modulated by the modulator is supplied to the directional coupler.

12. A tuner comprising:
a terrestrial input terminal that inputs a terrestrial broadcast signal;
a CATV input and output (I/O) terminal that inputs a CATV signal from a CATV network, or outputs a signal to the CATV network;
a branch circuit that branches or splits the CATV signal input from the CATV network through the CATV I/O terminal;
a selector that selects one of the terrestrial broadcast signal input by the terrestrial input terminal and the CATV signal branched or split by the branch circuit;
a main tuner that tunes to a predetermined channel from the signal selected by the selector; and
a controller that controls the selector and the main tuner,
wherein the controller branches or splits the CATV signal input from the CATV network through the CATV I/O terminal, or outputs the signal to the CATV network through the CATV I/O terminal, regardless of the signal selected by the selector.
